(19) United States
(12) Patent Application Publication
(10) Pub. No.: US 2017/0264942 A1
(43) Pub. Date: Sep. 14, 2017

(54) Method and Apparatus for Aligning Multiple Audio and Video Tracks for 360-Degree Reconstruction

(71) Applicant: MEDIATEK INC., Hsin-Chu (TW)

(72) Inventors: Chia-Ying LI, Taipei City (TW); Xin-Wei SHIH, Changhua City (TW); Chao-Ling HSU, Hsinchu City (TW); Shen-Kai CHANG, Zhubei City (TW); Yiou-Wen CHENG, Hsinchu City (TW)

(21) Appl. No.: 15/453,781

(22) Filed: Mar. 8, 2017

Related U.S. Application Data
(60) Provisional application No. 62/306,663, filed on Mar. 11, 2016.

(51) Int. Cl. H04N 21/43; H04N 21/439; H04N 21/44; H04N 21/81; H04N 5/265; G11B 27/10

(52) U.S. Cl. CPC H04N 21/4307; H04N 5/265; G11B 27/10; H04N 21/44016; H04N 21/816; H04N 21/4394

(57) ABSTRACT

Methods and apparatus of reconstructing 360 audio/video (AV) file from multiple AV tracks captured by multiple capture devices are disclosed. According to the present invention, for multi-track audio/video data comprising a first and second audio tracks and a first and second video tracks, the first audio track and the first video track are aligned with the second audio track and the second video track by utilizing video synchronization information derived from the first video track and the second video track if the video synchronization information is available. When the video synchronization information is available, the first audio track and the first video track are aligned with the second audio track and the second video track by utilizing the video synchronization information.

### CROSS REFERENCE TO RELATED APPLICATIONS

The present invention claims priority to U.S. Provisional Patent Application, Ser. No. 62/306,663, filed on Mar. 11, 2016. The U.S. Provisional Patent Application is hereby incorporated by reference in its entirety.

### FIELD OF THE INVENTION

The present invention relates to 360-degree audio and video reconstruction from multiple audio and video tracks generated from multiple capture devices. In particular, the present invention relates to audio and video synchronization among different audio and video tracks.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

The 360-degree video involves the capturing a scene using multiple cameras to cover a panoramic view, such as 360-degree field of view. The set of cameras (or capturing devices) are arranged to capture 360-degree field of view along with audio for each video. Typically two or more capture devices are used for capturing the 360-degree video with associated audio. The video and audio from multiple capture devices are used to form reconstructed 360-degree video and reconstructed 360-degree audio. The audio and video from each capture device are referred as an audio track and a video track respectively in this disclosure.

In 360-degree audio/video recording scenario, the video and audio tracks recorded from multiple capture devices need to be aligned. Each capture device may use its own setting. The 360-degree audio and 360-degree video are also referred as 360 audio and 360 video for abbreviation respectively. Often each capture device may be operated at its own clock and there is no common clock among various capture devices. Therefore, the audio/video tracks from various capture devices may not be aligned. There are also other factors causing the alignment issue among various capture devices. For example, device settings for the capture devices may be different.

FIG. 1 illustrates the scenario of alignment issue during 360 audio and video reconstructions. As shown in FIG. 1, N capture devices (110-1, 110-2, . . . , 110-N) are used and N is an integer equal to or greater than 2. Each capture device generates a corresponding audio track (120-1, 120-2, . . . , or 120-N) and a corresponding video track (130-1, 130-2, . . . , or 130-N). These audio tracks are provided to a 360 audio reconstruction unit 140 to generate reconstructed 360 audio and video tracks are provided to a 360 video reconstruction unit 150 to generate reconstructed 360 video. Both the reconstructed 360 audio and the reconstructed 360 video are included in the 360 file 160. Since the audio tracks and video tracks from different capture devices may not be synchronized, how to synchronize these audio and video tracks becomes an issue for 360 audio reconstruction and 360 video reconstruction.

Various 360 audio reconstruction technologies are known in the field. For example, audio signal processing can be used to generate spatial audio as a means for creating 360 audio. With 360 audio reconstruction, a user can hear the sound according to his/her viewing direction, and achieve an immersive sound experience. There are various 360 audio forms being widely used, such as channel-based, object-based or scene-based. Various image/video stitching technologies are known in the field. Also there are various virtual reality (VR) video formats or 360 video formats, such as spherical format and cubic format. These technologies are known in the art. Since the present invention focuses on the synchronization issues among various audio/video tracks, the details of 360 audio reconstruction and 360 video reconstruction are omitted in this application.

Due to the synchronization issue among various audio/video tracks, it is desirable to develop audio/video alignment technique to properly align the audio/video tracks from various capture devices to improve the quality of reconstructed 360 audio and video.

### BRIEF SUMMARY OF THE INVENTION

Methods and apparatus of reconstructing 360 audio/video (AV) file from multiple AV tracks captured by multiple capture devices are disclosed. According to the present invention, for multi-track audio/video data comprising a first and second audio tracks and a first and second video tracks, the first audio track and the first video track are aligned with the second audio track and the second video track by utilizing video synchronization information derived from the first video track and the second video track if the video synchronization information is available. When the video synchronization information is available, the first audio track and the first video track are aligned with the second audio track and the second video track by utilizing the video synchronization information, 360 audio is generated from aligned audio tracks including the first audio track and the second audio track, and 360 video is generated from aligned video tracks including the first video track and the second video track.

In one embodiment, obvious featured segment detection is applied to the first audio track and the second audio track and obvious object motion detection is applied to the first video track and the second video track. The obvious featured segments can be detected by comparing audio signal energy with an audio threshold and an audio segment is declared as an obvious featured segment if the audio signal energy of the audio segment exceeds the audio threshold.

If no obvious featured segment is detected and obvious object motion is detected, a video sync point is derived as the video synchronization information from the first video track and the second video track according to the obvious object motion. The video sync point is used for aligning the first audio track and the first video track with the second audio track and the second video track. Auto-correlation is used for aligning the first audio track with the second audio track by using the video sync point as a reference starting point of auto-correlation between the first audio track and the second audio track to refine audio alignment. Video stitching with feature matching is used to generate the 360 video from the aligned video tracks.

If at least one obvious featured segment is detected and obvious object motion is also detected, an audio sync point is derived from the obvious featured segment and a video sync point is also derived as the video synchronization information from the first video track and the second video track according to the obvious object motion. Whether the audio sync point and the video sync point matches is checked. If the audio sync point and the video sync point do not match, new obvious featured segment and new obvious object motion are detected again to derive a new audio sync point and a new video sync point with better match. If the audio sync point and the video sync point match, audio/video matching errors based on the audio sync point and the video sync point are evaluated. The audio sync point or the video sync point is selected for audio/video alignment based on one selection that achieves a smaller audio/video matching error. If the audio sync point achieves the smaller audio/video matching error, the audio sync point is used to align the first video track and the second video track. If the video sync point achieves the smaller audio/video matching error, auto-correlation is used for aligning the first audio track with the second audio track by using the video sync point as a reference starting point of auto-correlation between the first audio track and the second audio track to refine audio alignment. The audio/video matching error based on the audio sync point is calculated based on aligned audio tracks and align video tracks, where the first audio track and the second audio track are aligned using auto-correlation according to the audio sync point, and the first video track and the second video track are aligned using a video sync point closest to the audio sync point. The audio/video matching error based on the video sync point is calculated based on aligned audio tracks and align video tracks, where the first audio track and the second audio track are aligned by using the video sync point as a reference starting point of auto-correlation between the first audio track and the second audio track to refine audio alignment, and the first video track and the second video track are aligned using the video sync point.

If no obvious object motion is detected and no obvious featured segment is detected, the audio threshold is lowered until at least one obvious featured segment is detected. After said at least one obvious featured segment is detected, an audio sync point is derived from said at least one obvious featured segment using auto-correlation between the first audio track and the second audio track and the audio sync point is used to align the first audio track and the second audio track. The first video track and the second video track are aligned according to the audio sync point, where a video sync point closest to the audio sync point is selected to align the first video track and the second video track.

### BRIEF DESCRIPTION OF THE DRAWINGS

FIG. 1 illustrates a scenario of alignment issue during 360 audio and video reconstructions, where N audio/video tracks from N capture devices are reconstructed to form 360 audio and 360 video, and the audio/video tracks may be offset.

FIG. 2 illustrates an example of the wave spike based audio alignment technique, where wave spike in audio track #1 and corresponding wave track in audio track #2 are identified and used for audio alignment.

FIG. 3 illustrates an example of featured segment detection based on signal energy, where three featured segments are detected for sound tract #1 and three corresponding featured segments are detected for sound tract #2.

FIG. 4 illustrates an example of video stitching using Scale-Invariant Feature Transform (SIFT).

FIG. 5 illustrates an exemplary audio/video alignment process for Scenario 1 according to an embodiment of the present invention, where obvious featured segments are detected and no obvious object motion is detected.

FIG. 6A illustrates an example of audio sync point determination based on obvious featured segments according to an embodiment of the present invention for Scenario 1, where an obvious featured signal is detected for audio track #1 and audio track #2.

FIG. 6B illustrates an example of audio tracks and video tracks alignment using audio sync point according to an embodiment of the present invention for Scenario 1.

FIG. 7 illustrates an exemplary audio/video alignment process for Scenario 2 according to an embodiment of the present invention, where no obvious featured segment is detected, but obvious object motion is detected.

FIG. 8A illustrates an example of audio sync point determination based on obvious object motion according to an embodiment of the present invention for Scenario 2, where an obvious object motion is detected for video track #1 and video track #2.

FIG. 8B illustrates an example of audio/video alignment according to an embodiment of the present invention for Scenario 2, where the video sync point is used to assist audio alignment.

FIG. 9 illustrates an exemplary audio/video alignment process for Scenario 3 according to an embodiment of the present invention, where both obvious featured audio signal and obvious object motion are detected.

FIG. 10 illustrates an exemplary audio/video alignment process for Scenario 4 according to an embodiment of the present invention where no obvious featured audio signal and no obvious object motion are detected.

FIG. 11 illustrates an exemplary flowchart of a system that reconstructs 360 audio/video (AV) file from multiple AV tracks captured by multiple capture devices according to an embodiment of the present invention.

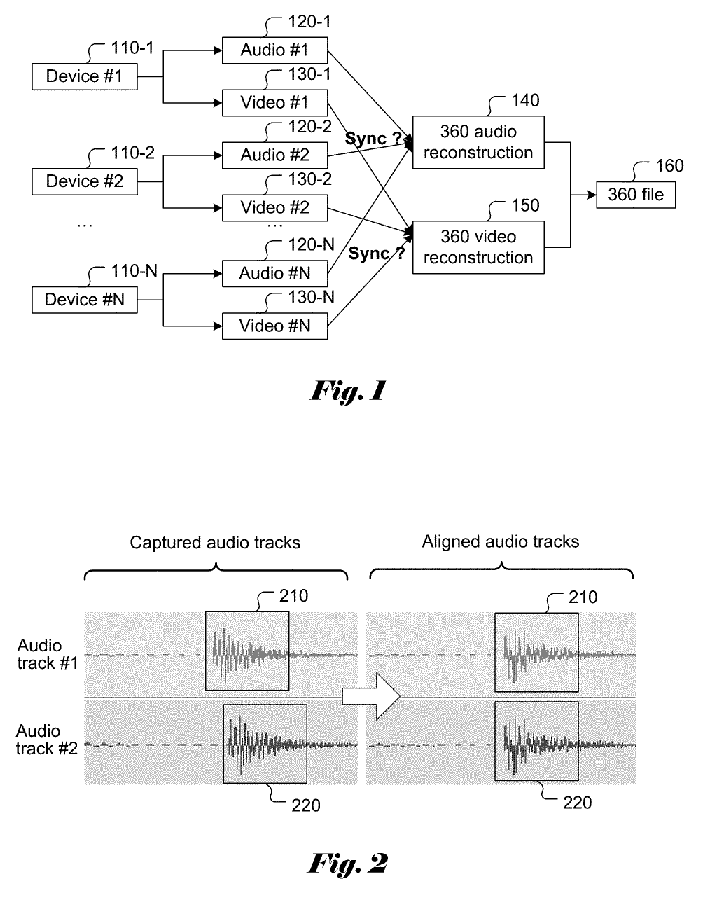

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, 360-degree audios and videos usually are captured using multiple capture devices associated with separate perspectives. Individual audio and video tracks are reconstructed to form 360-degree audio and video. According to a state of the art technology, the audio tracks are aligned by determining sound wave spike(s) corresponding to clap board or verbal announcement when the audio/video capturing starts. The two sound waves are then aligned manually. FIG. 2 illustrates an example of the wave-spike based alignment technique. Wave spike 210 in audio track #1 and corresponding wave track 220 in audio track #2 are identified. As shown in the left part of FIG. 2, these two wave spikes (i.e., 210 and 220) are offset. Since these two wave spikes correspond to a sound occurring at the same time instance. Therefore, these two wave spikes (i.e., 210 and 220) should be aligned as shown in the right part of FIG. 2. This technique may not be suitable for all occasions since it requires generating a noticeable sound at the beginning of recording.

There is a similar technique that uses automatic audio alignment. According to this automatic audio alignment technique, featured segments in an audio track are identified automatically using an audio matching technique (e.g., auto-correlation). Various techniques such as audio entropy calculation, signal energy or signal-to-noise (SNR) can be used to differentiate a “featured segment” from noise. As shown in FIG. 3, three featured segments 310 are detected for sound track #1 and three corresponding featured segments 320 are detected for sound track #2. The featured segments are offset between the two audio tracks as shown in the left part of FIG. 3. Auto-correlation is applied between candidate featured segments to achieve automatic audio alignment. In FIG. 3, the two audio tracks are aligned as shown in right part of FIG. 3. While the automatic audio alignment can align sound tracks without manual process, there are several issues with this approach. For example, the during the featured segment detection, a signal threshold may be set too high so that no featured segment is detected for matching. On the other hands, a signal threshold may be set too low so that too many featured segments are detected for matching, which will cause heavy computing complexity.

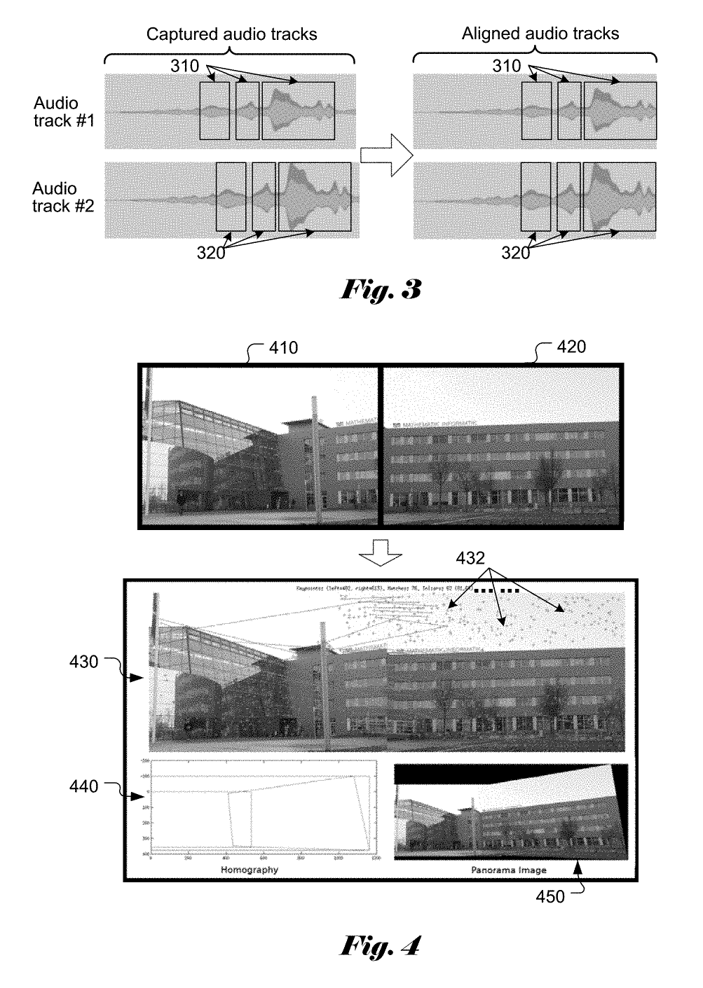

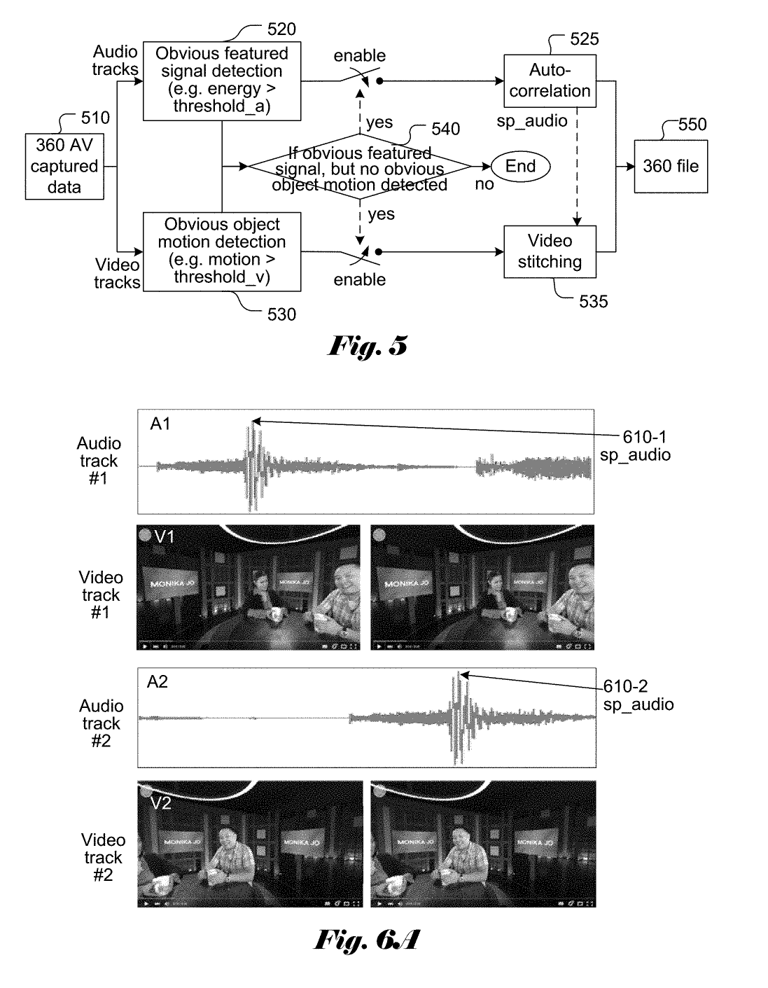

The 360 video is reconstructed by “stitching” the video tracks from the capture devices. There are various stitching techniques known in the art. Before two images can be stitched, correspondences between the two images have to be identified (i.e., registration). For example, feature-based registration and stitching can be used, where corresponding features between two images (particularly in the overlapped area between two images) are matched to identify the correspondences. The two images can then be stitched according to the matched features. Scale-Invariant Feature Transform (SIFT) is a technology that is often used for image stitching. FIG. 4 illustrates an example of video stitching using SIFT. Image 410 represents an image from video track #1 and image 420 represents an image from video track #2. The feature points (i.e., keypoints 432) for the pair of images 430 are identified. The homography 440 for the two images and the stitched panorama image 450 are shown in FIG. 4. For 360 video stitching from different video tracks, it is difficult to determine the video synchronization point when the scene is static.

In order to improve audio/video synchronization among different audio/video tracks so as to generate better 360 audio/video reconstruction, the present invention discloses techniques to utilize both audio and video information to perform automatic 360 audio/video reconstruction. While the conventional approach only checks whether an audio sync point can be determined, the present invention further utilizes video tracks to derive video sync point. Based on the combined conditions of audio sync point and video sync point, a suitable audio/video alignment process can be selected to align audio tracks and video tracks. The alignment process for various conditions of audio video sync point and video sync point are disclosed as follows.

Scenario 1: Sync Videos with Assistance of Audios

In this scenario, obvious featured audio signals are detected for the audio tracks and however, no obvious object motion can be detected in the video tracks. Accordingly, the audio sync point is determined and is used to assist video alignment for the video tracks.

FIG. 5 illustrates an exemplary audio/video alignment process for Scenario 1 according to an embodiment of the present invention. The 360 AV captured data 510 is provided to the alignment process. The 360 AV captured data 510 may correspond to pre-recorded 360 AV data or live 360 AV data from capture devices. The 360 AV captured data may be provided from the capture devices via wireless links (e.g. WiFi). The obvious featured signal detection for the audio tracks is performed in step 520. For example, the automatically featured segmentation mentioned previously can be used to extract featured segments from the audio tracks. In this case, the signal energy can be compared against a threshold (e.g. threshold_a) to determine whether there is any obvious featured signal existing in the audio tracks. On the other hand, the obvious object motion detection for the video track is performed in step 530. For example, the feature motion can be derived for each video track and obvious object motion is declared if the motion exceeds a threshold (e.g. threshold_v). The detection results from step 520 for audio and from step 530 for video are provided to step 540, where whether any obvious featured signal exists and whether no obvious object motion is detected (i.e., both conditions for Scenario 1) are checked. If both conditions are met, the auto-correlation process 525 for the audio tracks and the video stitching process 535 for the video tracks are applied by providing a control (i.e., the “yes” paths) from step 540 to enable the auto-correlation process 525 for the audio tracks and to enable the video stitching process 535 for the video tracks. Otherwise (i.e., the “no” path from step 540), the alignment process is ended. In this case, it implies that other conditions are met and other alignment process is applied to the audio tracks and video tracks. The audio sync point can be derived and the audio tracks can be aligned accordingly using auto-correlation process 525 as shown in FIG. 5. Furthermore, the audio sync point (i.e., sp_audio) information is provided to the video stitching process 535 to assist video alignment. For example, the video sync point (i.e., sp_video) closest to the audio sync point may be selected for video alignment. The 360 reconstructed audio and video are then included in the 360 AV file 550.

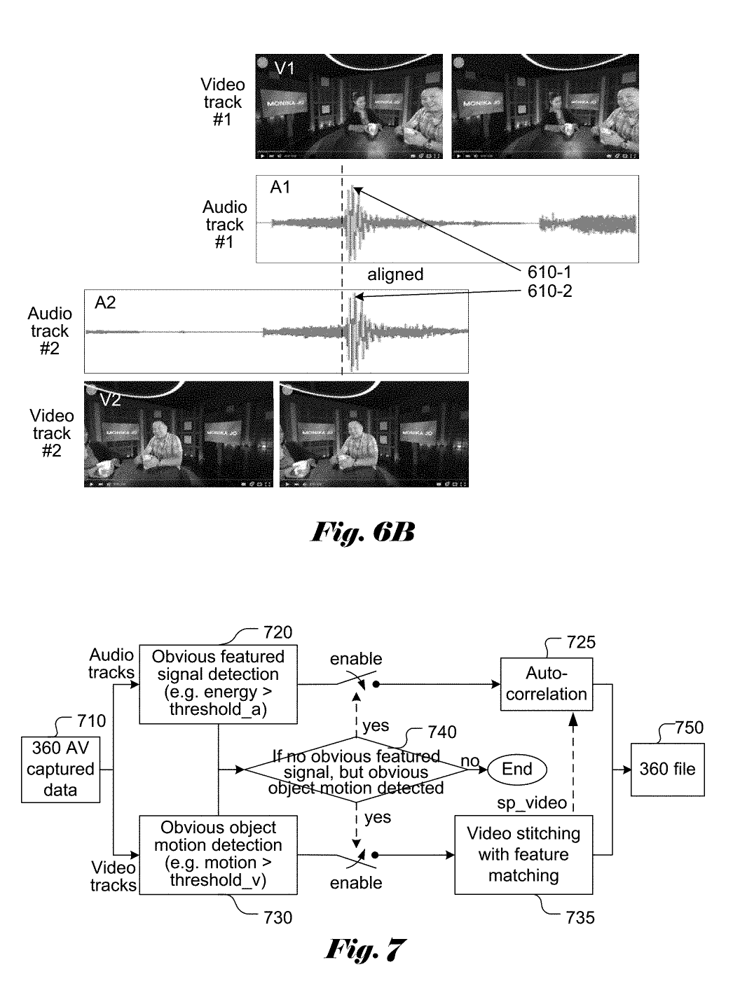

FIG. 6A and FIG. 6B illustrate an example of audio/video alignment according to an embodiment of the present invention for Scenario 1. As shown in FIG. 6A, the 360 AV captured data comprise audio track #1, video track #1, audio track #2 and video track #2. Obvious featured signals (610-1 and 610-2) are detected for audio track #1 and audio track #2. These obvious featured signals can be used to determine the audio sync point. The audio sync point can be derived using auto-correlation process 525, which is also used to align audio tracks. On the other hand, there is no obvious object motion being detected for the video tracks. Therefore, the audio/video alignment according to the above embodiment is applied to the audio tracks and video tracks. As shown in FIG. 6B, the multiple audio/video tracks are aligned according to the audio sync point. The corresponding video tracks are aligned according to the audio sync point. As shown in FIG. 6B, the two audio/video tracks are offset by about 1 video frame period. In this case, the video sync point can be selected as one that is closest to the audio sync point.

Scenario 2: Sync Audios with Assistance of Videos

In this scenario, no obvious featured audio signal is detected for the audio tracks and however, obvious object motion is detected in the video tracks. Accordingly, the video sync point is determined and is used to assist audio alignment for the audio tracks.

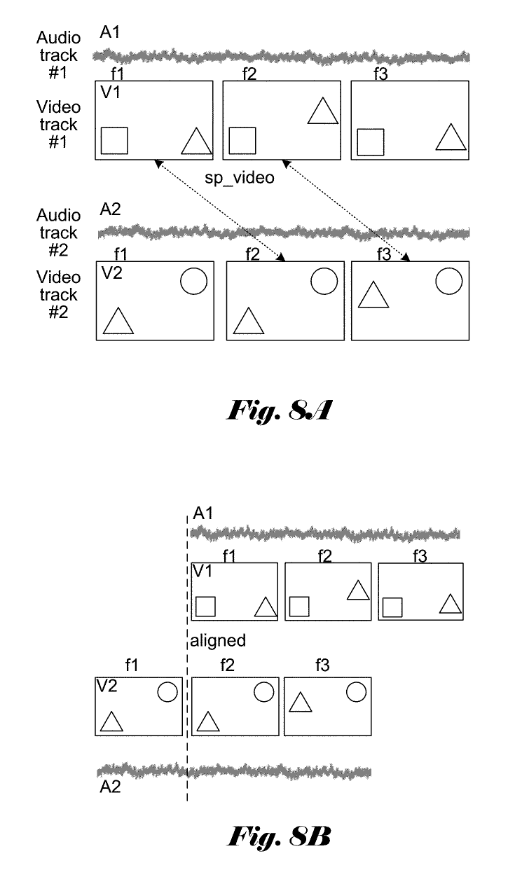

FIG. 7 illustrates an exemplary audio/video alignment process for Scenario 2 according to an embodiment of the present invention. The 360 AV captured data 710 is provided to the alignment process. The obvious featured signal detection for the audio tracks is performed in step 720. On the other hand, the obvious object motion detection for the video track is performed in step 730. The detection results from step 720 for audio and from step 730 for video are provided to step 740, where whether no obvious featured signal is detected and whether any obvious object motion exists (i.e., both conditions for Scenario 2) are checked. If both conditions are met, the auto-correlation process 725 for the audio tracks and the video stitching process with feature matching 735 for the video tracks are applied by providing a control (i.e., the “yes” paths) from step 740 to enable the auto-correlation process 725 for the audio tracks and to enable the video stitching process 735 for the video tracks. Otherwise (i.e., the “no” path from step 740), the alignment process is ended. In this case, it implies another condition is met and other alignment process is applied to the audio tracks and video tracks. The video sync point can be derived and the video tracks can be aligned accordingly using video stitching process with feature matching 735 as shown in FIG. 7. Furthermore, the video sync point (i.e., sp_video) information is provided to the audio auto-correlation process 725 to assist audio alignment. For example, the video sync point (i.e., sp_video) can be used as the reference starting point for audio auto-correlation. Since video sampling point (e.g. video time stamp) is much coarser than the starting point of audio auto-correlation process, finer audio alignment may be needed. With the known video sync point, it can reduce the search range for audio auto-correlation. The 360 reconstructed audio and video are then included in the 360 AV file 750.

FIG. 8A and FIG. 8B illustrate an example of audio/video alignment according to an embodiment of the present invention for Scenario 2. As shown in FIG. 8A, the 360 AV captured data comprise audio track #1, video track #1, audio track #2 and video track #2. No obvious featured signal can be detected for audio track #1 and audio track #2. However, obvious object motion is detected for the video tracks. For example, obvious motion is detected between frame 1 and frame 2 of video track #1. Corresponding obvious motion is detected between frame 2 and frame 3 of video track #2. Since the configuration of the multiple capture devices is known, the overlapping area of neighboring cameras can be determined. The object detection and motion estimation can be applied at least to the overlapping area of consecutive frames of a given camera. The obvious object motion in the overlapping area can be determined accordingly. Therefore, the video sync point can be determined and video tracks can be aligned by aligning frame 1 of video track #1 with frame 2 of video track #2 as shown in FIG. 8B. Similarly, frame 2 of video track #1 is aligned with frame 3 of video track #2. The audio tracks are initially aligned according to the video sync point. The audio auto-correlation can use the video sync point as a reference starting point to speed up the process.

Scenario 3: Sync with Obvious Video Motion and Obvious Featured Audio Signal

In this scenario, obvious featured audio signal is detected in the audio tracks and also obvious object motion is detected in the video tracks. Accordingly, both the video sync point and audio sync point are determined and used for audio and video alignment.

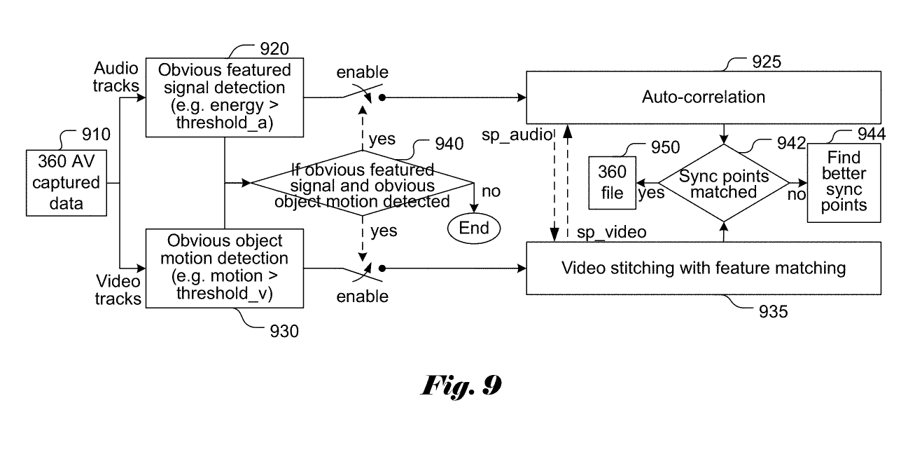

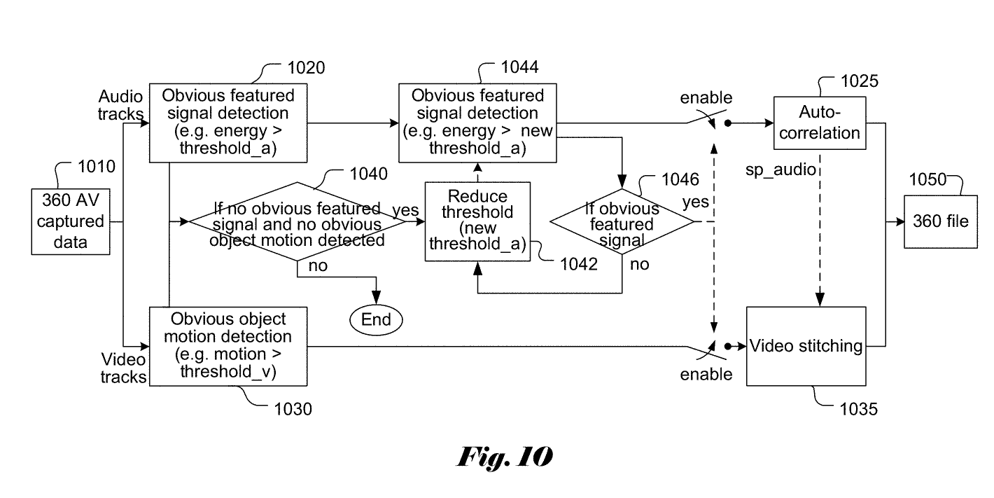

FIG. 9 illustrates an exemplary audio/video alignment process for Scenario 3 according to an embodiment of the present invention. The 360 AV captured data 910 is provided to the alignment process. The obvious featured signal detection for the audio tracks is performed in step 920. On the other hand, the obvious object motion detection for the video track is performed in step 930. The detection results from step 920 for audio and from step 930 for video are provided to step 940, where whether any obvious featured signal is detected and whether any obvious object motion is detected (i.e., both conditions for Scenario 3) are checked. If both conditions are met, the auto-correlation process 925 for the audio tracks and the video stitching process with feature matching 935 for the video tracks are applied by providing a control (i.e., the “yes” paths) from step 940 to enable the auto-correlation process 925 for the audio tracks and to enable the video stitching process 935 for the video tracks. Otherwise (i.e., the “no” path from step 940), the alignment process is ended. In this case, it implies that another condition is met and other alignment process is applied to the audio tracks and video tracks. Both the audio sync point and video sync point can be derived. The video tracks can be aligned accordingly using video stitching process with feature matching 935 as shown in FIG. 9. Furthermore, the video sync point (i.e., sp_video) information is provided to the audio auto-correlation process 925 to assist audio alignment. The audio sync point based audio/video alignment can also be applied and the matching audio/video error (referred as error_1) can be determined. The video sync point based audio/video alignment can be applied and the matching audio/video error (referred as error_2) can also be determined. The matching audio/video errors for audio sync point based alignment (i.e., error_1) and the matching audio/video errors for video sync point based alignment (i.e., error_2) are compared. The 360 reconstructed audio and video with lower matching audio/video error are included in the 360 file 950. When the obvious featured signal is detected in the audio tracks and the obvious object motion is detected in the video tracks, the derived audio and video sync points may not be matched. Accordingly, in another embodiment, whether the audio sync point and the video sync point are matched is checked in step 942. If the sync points are matched (i.e., the “yes” path from step 942), the 360 reconstructed audio and video processed according to the audio or video sync point that achieves a lower matching audio/video error are included in the 360 file 950. Otherwise (i.e., the “no” path from step 942), a process is performed to find better sync points in step 944. The better sync points can be found, for example, by performing steps 920 and 930 again on subsequent audio/video data until the better sync points is found. In other words, an embodiment of the present invention selects a best sync point that achieves the lowest matching error between the audio sync point and the video sync point.

Scenario 4: Sync with No Obvious Video Motion and No Obvious Featured Audio Signal

In this scenario, no obvious featured audio signal is detected for the audio tracks and also no obvious object motion is detected in the video tracks.

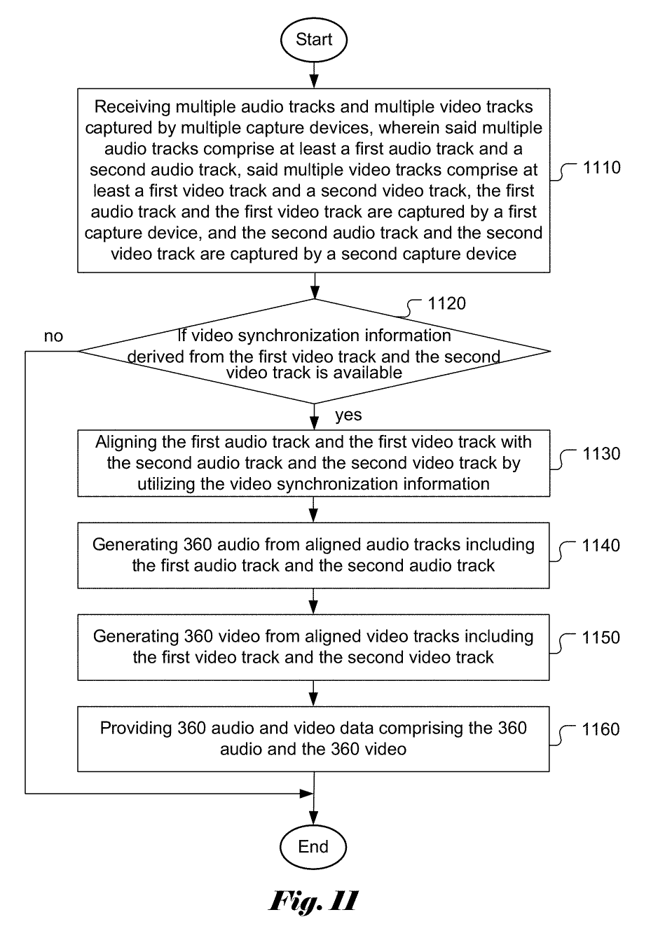

FIG. 10 illustrates an exemplary audio/video alignment process for Scenario 4 according to an embodiment of the present invention. The 360 AV captured data 1010 is provided to the alignment process. The obvious featured signal detection for the audio tracks is performed in step 1020. On the other hand, the obvious object motion detection for the video track is performed in step 1030. The detection results from step 1020 for audio and from step 1030 for video are provided to step 1040, where whether no obvious featured signal is detected and whether no obvious object motion is detected (i.e., both conditions for Scenario 4) are checked. If both conditions are met, the threshold or audio (i.e., threshold_a) is reduced and the new threshold_a is provided to obvious featured signal detection 1044 to perform obvious featured signal detection. The detection result is provided to step 1046, where whether obvious featured signal is detected is checked. If obvious featured signal is detected (i.e., the “yes” path from step 1046), the auto-correlation process 1025 for the audio tracks and the video stitching process 1035 for the video tracks are applied by providing a control (i.e., the “yes” paths) from step 1040 to enable the auto-correlation process 1025 for the audio tracks and to enable the video stitching process 1035 for the video tracks. Otherwise (i.e., the “no” path from step 1046), the threshold for audio (i.e., threshold-a) is reduced again until an obvious featured signal is detected. Since the audio sync point can be derived, the video tracks can be aligned according to the audio sync point and the aligned video tracks can be stitched using video stitching 1035 based on the audio sync point as shown in FIG. 10. For example, a video sync point closest to the audio sync point can be used for video alignment. In step 1040, if the result is “no”, the process is ended. In this case, it implies another condition is met and other alignment process is applied to the audio tracks and video tracks. The 360 reconstructed audio and video are then included in the 360 AV file 1050

FIG. 11 illustrates an exemplary flowchart of a system that reconstructs 360 audio/video (AV) file from multiple AV tracks captured by multiple capture devices according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, multiple audio tracks and multiple video tracks captured by multiple capture devices are received in step 1110, where said multiple audio tracks comprise at least a first audio track and a second audio track, said multiple video tracks comprise at least a first video track and a second video track, the first audio track and the first video track are captured by a first capture device, and the second audio track and the second video track are captured by a second capture device. As shown in FIGS. 5, 7, 9 and 10, 360 video captured data (i.e., multiple audio tracks and multiple video tracks captured by multiple capture devices) are provided for obvious featured signal detection and obvious object motion detection. The condition regarding “if video synchronization information derived from the first video track and the second video track is available” is checked in step 1120. This step includes step 740 in FIG. 7 and step 940 in FIG. 9. If the condition in step 1120 is satisfied (i.e., the “yes” path), steps 1130, through 1160 are performs. Otherwise (i.e., the “no” path from step 1120), the process is ended. In this case, it implies that another condition is met and other alignment process is applied to the audio tracks and video tracks. In step 1130, the first audio track and the first video track are aligned with the second audio track and the second video track by utilizing the video synchronization information. In step 1140, 360 audio is generated from aligned audio tracks including the first audio track and the second audio track and in step 1150, 360 video is generated from aligned video tracks including the first video track and the second video track. In step 1160, the 360 audio and video data comprising the 360 audio and the 360 video are then provided.

The flowchart shown above is intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of reconstructing 360 audio/video (AV) file from multiple AV tracks captured by multiple capture devices, the method comprising:
receiving multiple audio tracks and multiple video tracks captured by multiple capture devices, wherein said multiple audio tracks comprise at least a first audio track and a second audio track, said multiple video tracks comprise at least a first video track and a second video track, the first audio track and the first video track are captured by a first capture device, and the second audio track and the second video track are captured by a second capture device; and
if video synchronization information derived from the first video track and the second video track is available:
aligning the first audio track and the first video track with the second audio track and the second video track by utilizing the video synchronization information;
generating 360 audio from aligned audio tracks including the first audio track and the second audio track;
generating 360 video from aligned video tracks including the first video track and the second video track; and
providing 360 audio and video data comprising the 360 audio and the 360 video.

2. The method of claim 1, further comprising detecting one or more obvious featured segments in the first audio track and the second audio track, and detecting obvious object motion in the first video track and the second video track.

3. The method of claim 2, wherein said one or more obvious featured segments are detected by comparing audio signal energy with an audio threshold and one obvious featured segment is declared for one audio segment if the audio signal energy of said one audio segment exceeds the audio threshold.

4. The method of claim 2, if no obvious featured segment is detected and obvious object motion is detected, a video sync point is derived as the video synchronization information from the first video track and the second video track according to the obvious object motion and the video sync point is used for aligning the first audio track and the first video track with the second audio track and the second video track.

5. The method of claim 4, wherein auto-correlation is used for aligning the first audio track with the second audio track by using the video sync point as a reference starting point of auto-correlation between the first audio track and the second audio track to refine audio alignment.

6. The method of claim 4, wherein video stitching with feature matching is used to generate the 360 video from the aligned video tracks.

7. The method of claim 2, if at least one obvious featured segment is detected and obvious object motion is also detected, an audio sync point is derived from said at least one obvious featured segment and a video sync point is also derived as the video synchronization information from the first video track and the second video track according to the obvious object motion.

8. The method of claim 7, further comprising determining whether the audio sync point and the video sync point matches.

9. The method of claim 8, if the audio sync point and the video sync point do not match, said detecting one or more obvious featured segments in the first audio track and the second audio track, and said detecting obvious object motion in the first video track and the second video track are performed again to derive a new audio sync point and a new video sync point with better match.

10. The method of claim 8, if the audio sync point and the video sync point match, further comprising evaluating audio/video matching errors based on the audio sync point and the video sync point, the audio sync point or the video sync point is selected for audio/video alignment based on one selection that achieves a smaller audio/video matching error.

11. The method of claim 10, wherein if the audio sync point achieves the smaller audio/video matching error, the audio sync point is used to align the first video track and the second video track.

12. The method of claim 10, wherein if the video sync point achieves the smaller audio/video matching error, auto-correlation is used for aligning the first audio track with the second audio track by using the video sync point as a reference starting point of auto-correlation between the first audio track and the second audio track to refine audio alignment.

13. The method of claim 10, wherein the audio/video matching error based on the audio sync point is calculated based on aligned audio tracks and align video tracks, wherein the first audio track and the second audio track are aligned using auto-correlation according to the audio sync point, and the first video track and the second video track are aligned using a video sync point closest to the audio sync point.

14. The method of claim 10, wherein the audio/video matching error based on the video sync point is calculated based on aligned audio tracks and align video tracks, wherein the first audio track and the second audio track are aligned by using the video sync point as a reference starting point of auto-correlation between the first audio track and the second audio track to refine audio alignment, and the first video track and the second video track are aligned using the video sync point.

15. The method of claim 2, wherein said one or more obvious featured segments are detected by comparing audio signal energy with an audio threshold and one obvious featured segment is declared for one audio segment if the audio signal energy of said one audio segment exceeds the audio threshold; and if no obvious object motion is detected and no obvious featured segment is detected, the audio threshold is lowered until at least one obvious featured segment is detected.

16. The method of claim 15, wherein after said at least one obvious featured segment is detected, an audio sync point is derived from said at least one obvious featured segment using auto-correlation between the first audio track and the second audio track and the audio sync point is used to align the first audio track and the second audio track.

17. The method of claim 16, wherein the first video track and the second video track are aligned according to the audio sync point, wherein a video sync point closest to the audio sync point is selected to align the first video track and the second video track.

18. An apparatus of reconstructing 360 audio/video (AV) file from multiple AV tracks captured by multiple capture devices, the apparatus comprising one or more electronic circuits or processor arranged to:
receive multiple audio tracks and multiple video tracks captured by multiple capture devices, wherein said multiple audio tracks comprise at least a first audio track and a second audio track, said multiple video tracks comprise at least a first video track and a second video track, the first audio track and the first video track are captured by a first capture device, and the second audio track and the second video track are captured by a second capture device;
if video synchronization information derived from the first video track and the second video track is available:
align the first audio track and the first video track with the second audio track and the second video track by utilizing the video synchronization information;
generate 360 audio from aligned audio tracks including the first audio track and the second audio track;
generate 360 video from aligned video tracks including the first video track and the second video track; and
provide 360 audio and video data comprising the 360 audio and the 360 video.

19. The apparatus of claim 18, said one or more electronic circuits or processor are further arranged to detect one or more obvious featured segments in the first audio track and the second audio track and to detect obvious object motion in the first video track and the second video track.

20. The apparatus of claim 19, wherein said one or more obvious featured segments are detected by comparing audio signal energy with an audio threshold and one obvious featured segment is declared for one audio segment if the audio signal energy of said one audio segment exceeds the audio threshold.
